(19) United States
(12) Patent Application Publication
(10) Pub. No.: US 2005/0258566 A1
(43) Pub. Date: Nov. 24, 2005

(54) Battery electrodes with enlarged surfaces and method for production thereof

(75) Inventors: Herbert Naarmann, Frankenthal (DE); Frank Josef Kruger, Eppstein (DE); Stefan Theuerkauf, Nordhausen (DE)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: GAIA Akkumulatorenwerke GmbH, Nordhausen (DE)

(21) Appl. No.: 10/524,464

(22) PCT Filed: Aug. 18, 2003
(86) PCT No.: PCT/EP03/09119

§ 371 Date: Feb. 14, 2005

(30) Foreign Application Priority Data
Aug. 19, 2002 (DE) 102 37 870.3

(51) Int. Cl. B29C 47/00

(52) U.S. Cl. 264/176.1

(57) ABSTRACT

According to the invention, a method for the production of battery electrodes and battery electrodes produced with this method are provided, whereby the method comprises the production of compositions of the electrode materials for cathode or anode material and, if required, a separator material, and the extrusion of the electrode material to form the anode or cathode from the electrode material, and is characterized in that the electrode material comprises isocyanate and an aqueous dispersion of a polymer binder which react with one another to form porous structures. By means of the method according to the invention, extremely elastic and, at the same time, mechanically stable battery electrodes are generated that may be utilized in lithium secondary batteries.

### FIELD OF INVENTION

The invention relates to a method for the production of battery electrodes and battery electrodes produced with this method.

### BACKGROUND OF THE INVENTION

Devices that convert chemical energy into electrical energy are referred to as batteries. (Ullmann's Encyclopedia of Industrial Chemistry Vol. A3, 343-395, 1985 Publisher VCH, Weinheim).

Integral components of such devices are the electrodes that should have a surface that is as large as possible in order to achieve optimal reaction conditions for the conversion processes.

The conventional production of the electrodes occurs through the use of thin metal foils or compacting of powders, preferably by coating of the powdery reactants on current collectors. (“Elektrochemische Stromquellen”, K. Wiesener, I. Garche, M. Schneider, Publisher Akademie Verlag, Berlin 1981). In this so-called “liquid coating”, the respective materials for the anode and cathode are suspended in solutions of polymer binders and then applied to current collectors (Al, Cu or the like) as thin films. The solvent(s) is (are) drawn off in the drying tunnel and the anode and cathode—if necessary provided with a separator—encapsulated to the battery. In the production of rechargeable batteries, in particular Li-batteries, the production of the thin electro-strips (anode or cathode) and the arrangement of the separator are of particular importance in order to optimally realize the diffusion of the reactants (in particular conducting salts). (Varta Report 1/96—Rechargeable Li-batteries)

The disadvantages of the conventional methods are in the use of organic solvents for the required polymer binders, i.e. in the necessity of recycling due to environmental and cost reasons, availability of a sophisticated film coating technique (defined film thickness, avoidance of disturbances, defects, thickenings, flow forms, disturbing influences of foreign particles, required inert gas) and in the lack (or exclusion) of possibilities to influence the respective film of electrode material regarding arrangement, compacting and the like.

Consequently, the object according to the invention consists in providing a method for the production of battery electrodes and battery electrodes produced with this method that solve the aforesaid problems of the state of the art. In detail, the object of the invention comprises the provision of a method that does not require organic solvents in the production of the battery electrodes and may provide battery electrodes with an increased inner surface, as well as battery electrodes produced with this method.

### SUMMARY OF THE INVENTION

This object is solved by the characteristics of the independent claims 1 and 20. Further aspects of the object according to the invention are solved by the characteristics of the independent claims 2 to 19 and 21.

### DETAILED DESCRIPTION OF THE INVENTION

According to the method according to the invention for the production of battery electrodes, an electrode material is produced and from this electrode material, cathode or anode are formed, whereby the electrode material comprises isocyanate and an aqueous dispersion of a polymer binder which react with one another, preferable with the water of the dispersed polymer binder in order to form porous, in particular open-porous structures. In addition, where appropriate, a separator material is produced that is also extruded as subsequently described.

The batteries are preferably secondary lithium batteries.

The mixtures of the anode or cathode materials are preferably mixed in extruders and extruded and applied to current collectors as films of defined thickness, whereby the polymer binder (completely or partially) is dosed into the extruder as an aqueous dispersion, and isocyanate groups, preferably di-, tri-, or polyisocyanate-containing systems, are constituents of the anode or cathode material. Particulars of the method or the component mixtures are explained in the examples. The advantages of the method consist in the continuous production of defined porous anodes or cathodes without the use of unwanted solvents with the avoidance of recycling problems etc., the possibility to bring the anodes or cathodes to the desired thickness by pressing or laminating and subsequently—in consequence of the porous structure—to fill them with electrolyte (conducting salt+conducting salt solvent).

The porous structure of the anodes or cathodes is a characteristic of the invention and is generated through chemical reaction of the isocyanate groups with reactants, preferably with the water of the dispersed polymer binder. Through the quantity and nature of the isocyanate groups—containing systems (di-, tri-, and/or polyisocyanate) as well as the process control in the extruder (temperature, residence time, dosing of the polymer binder dispersion—speed and dosing arrangement-), the pore structure, i.e. the inner surface of the electrode materials, may be adjusted in a defined way. Information about isocyanates is to be gathered from Kunststoff-Lexikon 9^{th} Edition pp. 252/253 1998 and from Ullmann's Encyclopedia of Industrial Chemistry Vol. A 21, 665-711, 1992 Publisher Verlag Chemie Weinheim.

The electrode materials may preferably further comprise additives. Additives such as fillers, including SiO₂, acid catchers, inhibitors, including MgO, Al₂O₃, or amines or activators in organotin compounds or Lewis bases, including DABCO^{R} , are, for example, to be considered for this purpose. These additives may be comprised in quantities of 0.01 to 1 percent by weight.

The method for the production of battery electrodes comprises, for example, the following steps:

A: Production of the anode material (AM)

A1: Extrusion of the anode material

A2: Laminating of the anode material to the current collector

B: Production of the cathode material (KM)

B1: Extrusion of the cathode material

B2: Laminating of the cathode material to the current collector

The arrangement of the anode and the cathode with a separator and the encapsulation to a finished, ready-to-use battery occurs according to known processing steps.

A: As anode materials, the materials mentioned in Ullmann's on page 1 (1.c.) are to be considered, which are added to an isocyanate, preferably a di-, tri- or polyisocyanate. The quantity of the isocyanate is preferably 0.5-10 percent by weight based on the electrode material. If necessary, further polymers as powders or fine-grained granulate may be used, preferably in quantities of 0.1-10 percent by weight. The polymers are e.g. polyolefins, polyethylene, polypropylene, polyisobutene, polystyrene, rubbers on the basis of styrene/butadiene or isoprene or also fluoroelastomers, preferably terpolymers on the basis of TFE (tetrafluoroethylene), HFP (hexafluoropropylene), and VDF (vinylidene fluoride). The components are mixed, e.g. in a Voith-mixer, preferably at temperatures between 20 and 80° C.

A1: The mixture A is fed to an extrusion system (Collin 136/350 or E IGT or the like). The extruder (compare Collin-company magazine: Extrusion systems) preferably comprises the following devices: throttle valves for the adjustment of the throughput, adjustable slit widths (thickness and width), continuously variable heating, dosing (gravimetrically or volumetrically controlled), parallel rotating or counter rotating twin screws, and degasification nozzle.

The extrusion is preferably carried out at temperatures of 80 to 180° C. (e.g. discharge slit die), preferably 120 to 140° C. Temperatures of 80 to 100° C. (e.g. feed zone) may also be set. The aqueous dispersion (e.g. Dyneon THV®) of the polymer binder may be introduced in the feed zone via a dosing pump, for example at temperatures of 20 to 100° C. The quantity of the metered polymer dispersion is preferably 1-15 percent by weight (based on the entire anode material).

A2: The anode material that discharges e.g. from the slit die, (width 30-500 μm, preferably 10-400 μm), thickness 5 to 1,000 μm, preferably 10-400 μm, temperature e.g. 110-180° C., preferably 120-140° C., may be brought together with a current collector strip (current collector) made of metal, e.g. Cu-foil, and laminated (pressure typically up to 100 bar, preferably 2-10 bar). The discharging anode material is through the reaction of the isocyanate preferably open-porously structured and is pressed to the desired thickness or porosity through the pressure during lamination to the current collector.

The processes B, B1, and B2 for the cathode occur analogously.

Compounds generally known in the art are considered as isocyanates. Especially preferred are isophorone diisocyanate, 1,4-cyclohexane diisocyanate, Uretidon-Desmodur TT®, Prepolymer-Desmodur VP-PU 0137®, naphthalene 1,5-diisocyanate and the like which are preferably premixed with the respective anode or cathode material.

However, the possibility to carry out the addition of the isocyanate systems according to the invention via a separate metered addition in the extruder also exists.

Suitable as polymer binder dispersion are aqueous dispersions with nonionic emulsifiers or salts of perfluorocarboxylic acids, preferably with a number of carbon atoms of more than 6, and polymers on the basis of fluoropolymers, in particular co- or terpolymers, e.g. Dyneon THV®.

Subsequently, the invention is explained by means of preferred examples. However, it is by no means limited to these.

### EXAMPLE 1

Production of a cathode material: 2,600 parts LiCoO₂ SS5^{R} are mixed (Voith-mixer, room temperature, 60 minutes) with 300 parts Ensaco 200^{R} (conducting carbon black) (Erachem) as well as 50 parts Desmodur 15® (naphthalene 1,5-diisocyanate) (Bayer) and this mixture is fed into a Collin-extruder that is operated at an internal temperature of 100-110° C., simultaneously, 1,500 parts of an aqueous dispersion (35%) of a terfluoropolymer THV Dyneon 120 D® (3M) are fed into the extruder, that has a degasification nozzle, via a dosing pump. With a residence time of 1-3 minutes in the mixing area of the extruder, the material is removed via a slit die (150 mm wide, thickness of the slit 15 μm). The material discharges as a continuous film and has a thickness of 25-40 μm, the discharging cathode material is applied to a prime coated Al-foil and dried at 150-180° C. The properties and mode of action of these electrodes in a Li-polymer battery are shown in the following table.

### EXAMPLE 2

Polyisocyanate and binder are fed in as dispersion. In case it is operated as described in example 1, however without isocyanate in the mixture, but with a polyisocyanate dispersion aqueous 40% (100 parts) that is combined with 1,300 parts of the aqueous polymer dispersion (analogous to example 1) and simultaneously dosed into the extruder, a cathode material is obtained that has a thickness of 30-45 μm and is also dried in the drying tunnel at 120-185° C. This material shows an open-porous structure as well. The properties and mode of action of these electrodes in a Li-polymer battery are shown in the following table.

### EXAMPLE 3

Production of an anode material: 2,800 parts of synthetic graphite MCMB 25/28^{R} are mixed as described in example 1 with 150 parts conducting carbon black Ensaco 250^{R} as well as 40 parts MdI-Desmodur^{R} (4,4′-methylene diphenyl diisocyanate) and dosed in a Collin-extruder in which simultaneously 1,500 parts of a 35% aqueous polymer dispersion (analogous to example 1) are pumped. As in example 1, a material is also extruded here that has a thickness of 25-45 μm and is continuously laminated to a Cu-foil and subsequently dried in the drying tunnel (120-180° C.). The structure of the material is porous; the residual moisture is <20 ppm. The properties and mode of action of these electrodes in a Li-polymer battery are shown in the following table.

### EXAMPLE 4

Analogous to example 3, however with a polyol diisocyanate from TDI^{R} and poly(tetramethylene glycol) 40 parts (ratio TDI to glycol 1:1). In this case as well, an anode material is obtained from the slit die of the extruder that discharges with a thickness of 30 to 50 μm, is laminated to Cu-foil and has residual moisture after drying of <20 ppm and has an open-porous structure. The properties and mode of action of these electrodes in a Li-polymer battery is shown in the following table.

### EXAMPLE 5

Production of a composite of anode and cathode with a separator as intermediate layer. The anode (example 3) and the cathode (example 1) are provided with an intermediate layer e.g. Cellgard^{R}, namely in such a way that the Cellgard is introduced between anode and cathode so that the current collectors are the outer layer of the composite system. Before the laminating of anode, intermediate layer (Cellgard) and cathode, the films are moistened with a 1 molar solution of LiPF₆ in ethylene carbonate, diethylene carbonate, and dimethyl carbonate (1:1:1), in each case 1,500 g onto 5,000 g of the total mass; after the moistening this corresponds to soaking of the porous materials with the electrolyte and at temperatures of 20-120° C. and pressures of 1-100 bar (corresponding to 0.1 mPa to 10 mPa). The composite system is then conventionally processed to prismatic or winding cells and is after housing and poling (i.e. contacting of the anode or cathode end faces with the positive or negative pole of the ready-to-use battery. The properties and mode of action of these electrodes in a Li-polymer battery is shown in the following table.

### EXAMPLE 6

Production of a cathode material with aqueous polymer dispersion but without isocyanate additive. In case it is operated according to example 1 without addition of Desmodur^{R}, a film is obtained under otherwise identical process operation that on discharging from the extruder die has a thickness of 15-30 μm and, after drying, moisture of <20 ppm. The properties and mode of action of these electrodes in a Li-polymer battery is shown in the following table.

### EXAMPLE 7

Production of an anode material without isocyanante additive. In case it is operated according to example 3, however without the addition of the MdI-Desmodur^{R}, it is also obtained a film, under otherwise identical operating conditions, that on discharging from the extruder die has a thickness of 18-25 μm and, after drying, moisture of <20 ppm. The properties and mode of action of these electrodes in a Li-polymer battery is shown in the following table.

### EXAMPLE 8

Production of a Separator:

In a Collin-extruder, 200 parts of a prepolymer on the basis of poly(tetramethylene glycol), molar mass 5-10,000, and MDi^{R} as co-reactant are metered (ratio polyol to MDi weight 1:1), and 1,500 parts of a 50% dispersion comprising 600 parts of Dyneon THV^{R} and 150 parts of conducting carbon black Ensaco^{R} as well as a slurry of 100 parts of MgO/Al₂O₃ (weight 1:1) in 500 parts of water is dosed. The extruder operates at temperatures of 100° C. -120° C., part of the water is withdrawn via a degasifying nozzle. A porous material is discharging from the die of the extruder that is removed via release paper and dried at 120-180° C. The obtained film has a thickness of ˜30 μm and after drying a water content of <20 ppm. The film is suitable as intermediate layer for the composite system with anode and cathode since its porosity allows the take-up of electrolytes, and it is sufficiently resistant to tearing and elastic for a further continuous processing process.

TABLE 1

| | Pore Ø μm | | |
|---|---|---|---|
| | (ASTM | QT-FS-1010 | |
| | 316) | Porosity (%) | Surface m²/g |
| Cathode material according | 0.1-1.5 | 95 | 0.5 |
| to ex. 1 | | | |
| Cathode material according | 0.1-1.5 | 90-95 | 0.3 |
| to ex. 2 | | | |
| Anode material according to | 0.1-2 | 95 | 0.6 |
| ex. 3 | | | |
| Anode material according to | 0.1-3 | 95 | 0.6 |
| ex. 4 | | | |
| Separator material according | 0.1-1.6 | 65 | 0.5 |
| to ex. 8 | | | |
| Anode material according to | 0.3-1.5 | 80-85 | 0.08 |
| ex. 6 | | | |
| Anode material according to | 0.3-1.5 | 75-80 | 0.1 |
| ex. 7 | | | |
| Solupor 8PO7A Company | 0.7 | 85 | 0.2 |
| DSM | | | |
| Polyethylene with | | | |
| micropores | | | |
| Celgard ® 2700 Celgard | 0.2-0.3 | 37 | 0.2 |
| Incorp. | | | |

Production of a Battery:

The composite of anode/separator and cathode produced according to the examples is rolled into a winding and contacted via the winding face surfaces, +poled -, and then installed. The winding diameter is 8.2 cm, the charging (galvanostatic) occurs by means of a Digatron-charger stepwise from 3.0 via 3.6 and then up to 4.2 Volt; in each case with currents of 0.15 mA/cm².

The discharge also occurs with currents of 0.15 mA/cm².

Winding cells were produced from:

| | | |
|---|---|---|
| 1)* | Cathode material example 1 | Discharge capacity A |
| | +Anode material example 3 | 52 |
| 2)* | Cathode material example 2 | 54 |
| | +Anode material example 4 | |
| 3)* | Cathode material example 6 | 62 |
| | +Anode material example 3 | |
| 4)* | Cathode material example 2 | 60 |
| | +Anode material example 7 | |
| 5) | Cathode material example 1 | 52 |
| | +Anode material example 3 | |
| | With Cellgard as separator | |
| 6) | Cathode material example 1 | 52 |
| | +Anode material example 3 | |
| | With Solupor as separator | |

| 7) | Cathode materials or anode materials are not produced with | |
|---|---|---|
| | the method according to the invention but through extrusion | |
| | of the equivalent quantities of fluoroelastomers, thus with- | |
| | out isocyanate additives and not as aqueous dispersions, | |
| | that way, discharge capacities between 35 and 40 Ah are | |
| | obtained under analogous conditions (7a, 7b), e.g.: | |
| | 7a. | Cathode material example 1 without diisocyanate |
| | | and 525 parts perfluoropolymer THV Dyneon 120 ® |
| | | +Anode material example 3 without diisocyanate and |
| | | (as above) 525 parts of THV Dyneon 120 ® with |
| | | separator according to example 8 |
| | 7b. | like 7a, but with Cellgard as separator. |

*In each case with the separator material example 8

1. A method for producing an extruded electrode material for use in a battery, the method comprising:
extruding a cathode material composition or an anode material composition, said composition comprising isocyanate and an aqueous dispersion of a polymer binder wherein
the isocyanate reacts with the aqueous dispersion of the polymer binder to form an extruded electrode material having a porous structure.

2. The method according to claim 1, wherein the isocyanate is selected from the group consisting of di-, tri-, and polyisocyanates.

3. The method according to claim 1 wherein the isocyanate is selected from the group consisting of isophorone diisocyanate, 1,4-cyclohexane diisocyanate, 1,3-bis(3-isocyanato-4-methylphenyl)-2,4-dioxo-1,3-diazetidine), a reaction product of poly(butene adipate) and a mixture comprising 65% toluene 2,4-diisocyanate and 35% toluene 2,6-diisocyanate, and naphthalene 1,5-diisocyanate.

4. The method according to claim 1, wherein the polymer binder is selected from the group consisting of polyolefins, polyethylene, polypropylene, polyisobutene, polystyrene, rubbers based on styrene/butadiene, rubbers based on isoprene, and a fluoroelastomer.

5. The method according to claim 4, wherein the aqueous dispersion of the polymer binder comprises a nonionic emulsifier comprising a perfluorocarboxylic acid having more than 6 carbon atoms.

6. The method according to claim 1, wherein the extruded electrode material comprises an open-porous structure.

7. The method according to claim 1, wherein the extrusion of the anode material composition or the cathode material composition occurs at temperatures of 80 to 180° C.

8. The method according to claim 1, further comprising the step of laminating the extruded electrode material to a current collector film.

9. The method according to claim 1, wherein the isocynate comprises 0.5 to 10 percent by weight of the anode material composition or the cathode material composition.

10. The method according to claim 1, wherein the aqueous dispersion of the polymer binder comprises 1 to 15 percent by weight of the anode material composition or the cathode material composition.

11. The method according to claim 1, wherein the anode material composition comprises carbon.

12. The method according to claim 1, wherein the cathode material composition comprises a metal oxide.

13. The method according to claim 1, wherein the anode material composition or the cathode material composition comprises one or more additives selected from the group consisting of fillers, acid catchers, inhibitors, amines, activators in organotin compounds, and Lewis bases.

14. The method according to claim 13, wherein the additives comprise 0.01 to 1 percent by weight of the anode material composition or the cathode material composition.

15. The method according to claim 8, wherein the laminating occurs at pressures of 2-10 bar.

16. The method according to claim 1, wherein the extrusion occurs in an extruder and the aqueous polymer dispersion is pumped into a feed zone of the extruder at temperatures of 20-100° C.

17. The method according to claim 1, wherein the extruded electrode material is removed through a slit die of an extruder having a width of 30 to 500 mm and a thickness of 5 to 1,000 μm.

18. The method according to claim 1, wherein the extruded electrode material comprises a porous film.

19. A method for producing a battery, the method comprising:
providing a cathode formed from the extruded material produced according to the method of claim 1;
providing an anode formed from the extruded material produced according to the method of claim 1;
disposing a separator between the anode and the cathode to form a composite;
laminating the composite; and
applying electrical contacts to the composite to form the battery.

20. The method according to claim 19 wherein the battery separator comprises a porous structure.

21. A battery electrode comprising an extruded electrode material produced according to the method of claim 1.

22. The battery produced according to the method of claim 19 wherein the battery is a secondary lithium battery.

23. The method according to claim 4, wherein the polymer binder is selected from the group consisting of a copolymer of a fluoroelastamer and terpolymer of a fluoroelastomer.

24. The method according to claim 23 wherein the terpolymer comprises tetrafluoroethylene, hexafluoropropylene, and vinylidene fluoride.

25. The method according to claim 4, wherein the aqueous dispersion of the polymer binder comprises a perfluorocarboxylic acid salt having more than six carbon atoms.

26. The method according to claim 4, wherein the aqueous dispersion of the polymer binder comprises a fluoropolymer.

27. The method according to claim 26, wherein the fluoropolymer is selected from the group consisting of a copolymers of a fluoropolymer and a terpolymer of a fluoropolymer.

28. The method according to claim 7 wherein the extrusion of the anode material composition or the cathode material composition occurs at a temperature of 120 to 140° C.

29. The method according to claim 11 wherein the carbon in the anode material composition comprises intercalatable carbon.

30. The method according to claim 11 wherein the carbon in the anode material composition comprises graphite.

31. The method according to claim 12 wherein the metal oxide in the cathode material composition comprises an intercalatable metal oxide.

32. The method according to claim 12 wherein the metal oxide is an oxide of a metal selected from the group consisting of manganese, nickel, cobalt, titanium, chromium, molybdenum, and tungsten.

33. The method according to claim 13 wherein the fillers comprise SiO₂.

34. The method according to claim 13 wherein the inhibitors are selected from the group consisting of MgO and Al₂O₃.

35. The method according to claim 13 wherein the Lewis bases comprise 1,4-diazabicyclo[2.2.2]octane.
